(19) United States
(12) Patent Application Publication
(10) Pub. No.: US 2022/0327680 A1
(43) Pub. Date: Oct. 13, 2022

(54) INFORMATION PROCESSING APPARATUS, INFORMATION PROCESSING METHOD, AND COMPUTER READABLE MEDIUM

(71) Applicant: Mitsubishi Electric Corporation, Tokyo (JP)

(72) Inventor: Takahisa ENOMOTO, Tokyo (JP)

(73) Assignee: Mitsubishi Electric Corporation, Tokyo (JP)

(21) Appl. No.: 17/851,279

(22) Filed: Jun. 28, 2022

Related U.S. Application Data
(63) Continuation of application No. PCT/JP2020/006517, filed on Feb. 19, 2020.

(51) Int. Cl. G06T 7/00

(52) U.S. Cl. CPC G06T 7/0002; G06T 2207/30168; G06T 2207/30242

(57) ABSTRACT

A state deduction unit (102) deduces a state presented in a photographed image (200). An analysis-method selection unit (105) selects as an analysis method for analyzing the photographed image (200), an analysis method from among a plurality of analysis methods, based on a deduced state which is the state deduced by the state deduction unit (102), required accuracy which is analysis accuracy required for analysis of the photographed image (200), and a constraint condition for analyzing the photographed image (200).

### CROSS REFERENCE TO RELATED APPLICATIONS

This application is a Continuation of PCT International Application No. PCT/JP2020/006517, filed on Feb. 19, 2020, which is hereby expressly incorporated by reference into the present application.

### TECHNICAL FIELD

The present disclosure relates to a technique of analyzing a photographed image.

### BACKGROUND ART

There is a technique described in Patent Literature 1 as a technique of analyzing a photographed image. Patent Literature 1 discloses a technique of acquiring information regarding an environment of an area for which an image has been acquired, and switching object detection methods to be used or changing parameters to be used, when a state of the environment changes.

### CITATION LIST

### Patent Literature

Patent Literature 1: JP2008-47991A

### SUMMARY OF INVENTION

### Technical Problem

Generally, in analysis of the photographed image, in many cases, required analysis accuracy differs depending on a state presented in the photographed image. Further, an apparatus which analyzes the photographed image also performs processes such as reproducing, recording, and broadcasting of the photographed image, in addition to the analysis of the photographed image. Therefore, there exists a constraint condition that the computational resource usable for the analysis of the photographed image is constrained by the other processes.

However, the technique of Patent Literature 1 does not consider the state presented in the photographed image, the required analysis accuracy, and the constraint condition. Thus, the technique of Patent Literature 1 has a problem that the photographed image cannot be properly analyzed according to the state, the required accuracy, and the constraint condition.

One of the main objects of the present disclosure is to solve the above-described problem. More specifically, the present disclosure mainly aims to realize proper analysis of a photographed image according to a state, required accuracy, and a constraint condition.

### Solution to Problem

An information processing apparatus according to the present disclosure includes:

a state deduction unit to deduce a state presented in a photographed image; and

an analysis-method selection unit to select as an analysis method for analyzing the photographed image, an analysis method from among a plurality of analysis methods, based on a deduced state which is the state deduced by the state deduction unit, required accuracy which is analysis accuracy required for analysis of the photographed image, and a constraint condition for analyzing the photographed image.

### Advantageous Effects of Invention

According to the present disclosure, it is possible to realize proper analysis of a photographed image according to a state, required accuracy, and a constraint condition.

### BRIEF DESCRIPTION OF DRAWINGS

FIG. 1 is a diagram illustrating a functional configuration example of an information processing apparatus according to a first embodiment.

FIG. 2 is a diagram illustrating a hardware configuration example of the information processing apparatus according to the first embodiment.

FIG. 3 is a diagram illustrating an example of an analysis-method table according to the first embodiment.

FIG. 4 is a flowchart illustrating an operation example of the information processing apparatus according to the first embodiment.

FIG. 5 is a diagram illustrating a specific example of operation of the information processing apparatus according to the first embodiment.

FIG. 6 is a diagram illustrating a specific example of the operation of the information processing apparatus according to the first embodiment.

FIG. 7 is a diagram illustrating a functional configuration example of an information processing apparatus according to a second embodiment.

FIG. 8 is a diagram illustrating a specific example of operation of the information processing apparatus according to the second embodiment.

FIG. 9 is a diagram illustrating a specific example of the operation of the information processing apparatus according to the second embodiment.

FIG. 10 is a diagram illustrating a functional configuration example of an information processing apparatus according to a third embodiment.

FIG. 11 is a flowchart illustrating an operation example of the information processing apparatus according to the third embodiment.

FIG. 12 is a diagram illustrating a functional configuration example of an information processing apparatus according to a fourth embodiment.

FIG. 13 is a diagram illustrating a functional configuration example of an information processing apparatus according to a fifth embodiment.

FIG. 14 is a diagram illustrating an example of an analysis-method table according to the fifth embodiment.

FIG. 15 is a diagram illustrating a specific example of operation of the information processing apparatus according to the fifth embodiment.

FIG. 16 is a diagram illustrating a functional configuration example of an information processing apparatus according to a sixth embodiment.

FIG. 17 is a diagram illustrating a functional configuration example of an information processing apparatus according to a seventh embodiment.

### DESCRIPTION OF EMBODIMENTS

Hereinafter, embodiments will be described with reference to the drawings. In the following description of the embodiments and the drawings, parts assigned the same reference numerals indicate the same parts or corresponding parts.

### First Embodiment

### Description of Configuration

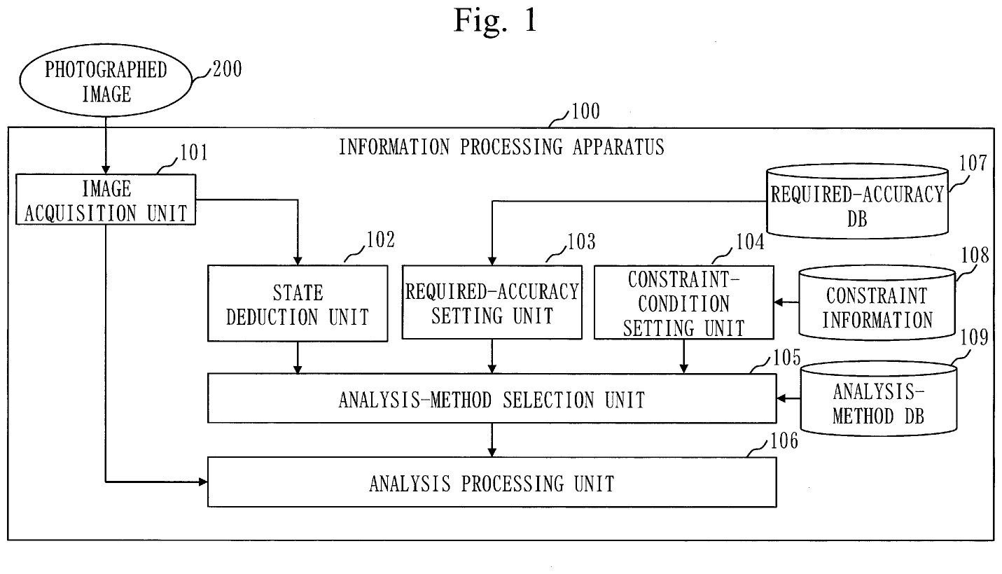

FIG. 1 illustrates a functional configuration example of an information processing apparatus 100 according to the present embodiment.

The information processing apparatus 100 is a computer. An operation procedure of the information processing apparatus 100 is equivalent to an information processing method. Further, a program which realizes operation of the information processing apparatus 100 is equivalent to an information processing program.

An image acquisition unit 101 acquires a photographed image 200. The photographed image 200 may be a static image or a moving image. The image acquisition unit 101 outputs the acquired photographed image 200 to a state deduction unit 102 and an analysis processing unit 106.

The state deduction unit 102 analyzes the photographed image 200 uncomplicatedly and deduces a state presented in the photographed image 200.

A process performed by the state deduction unit 102 is equivalent to a state deduction process.

A required-accuracy setting unit 103 refers to a required-accuracy DB 107 and sets analysis accuracy (hereinafter, referred to as required accuracy) required for analysis of the photographed image 200 by the analysis processing unit 106 which will be described later.

A process performed by the required-accuracy setting unit 103 is equivalent to a required-accuracy setting process.

A constraint-condition setting unit 104 refers to constraint information 108 and sets a constraint condition for analyzing the photographed image 200 by the analysis processing unit 106.

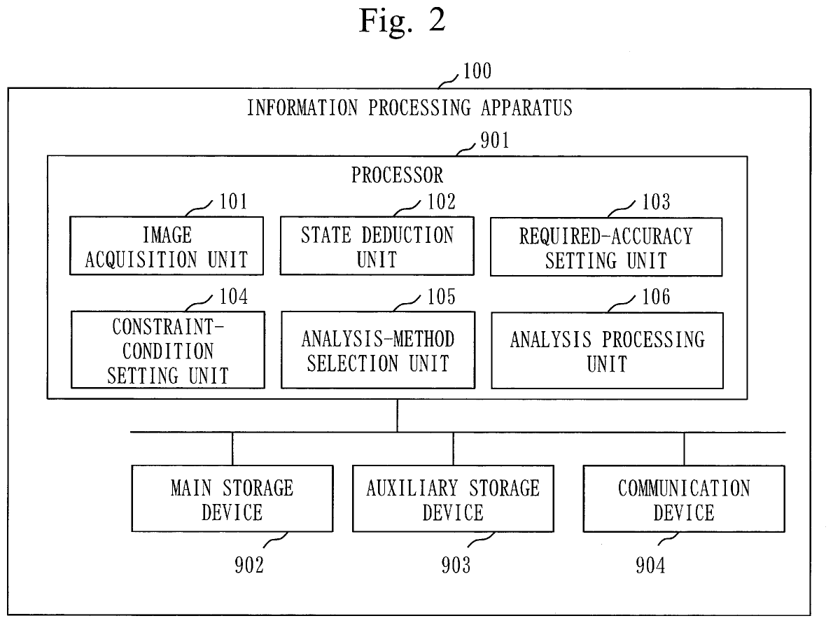

In the present embodiment, although descriptions will be mainly given to the analysis of the photographed image 200, in the information processing apparatus 100, computational resources are consumed for computational processes other than the analysis of the photographed image 200. Therefore, there is a constraint on the computational resource to be assigned to the analysis of the photographed image 200 by the analysis processing unit 106. According to the present embodiment, the constraint-condition setting unit 104 sets the constraint condition of the computational resource. Note that, the computational resources are hardware resources of the information processing apparatus 100 which will be described later with reference to FIG. 2.

A process performed by the constraint-condition setting unit 104 is equivalent to a constraint-condition setting process.

An analysis-method selection unit 105 selects an analysis method for analyzing the photographed image 200 by the analysis processing unit 106. More specifically, the analysis-method selection unit 105 selects as the analysis method for analyzing the photographed image 200 by the analysis processing unit 106, an analysis method from among a plurality of analysis methods, based on a deduced state which is the state deduced by the state deduction unit 102, the required accuracy set by the required-accuracy setting unit 103, and the constraint condition set by the constraint-condition setting unit 104.

A process performed by the analysis-method selection unit 105 is equivalent to an analysis-method selection process.

The analysis processing unit 106 analyzes the photographed image 200. More specifically, the analysis processing unit 106 analyzes the photographed image 200 according to the analysis method selected by the analysis-method selection unit 105.

The analysis processing unit 106 analyzes the image, using AI (Artificial Intelligence), for example.

The required-accuracy DB 107 stores a required-accuracy table. In the required-accuracy table, the required accuracy is written.

The constraint information 108 is information which consists a basis of setting of the constraint condition. The constraint information 108 indicates, for example, the amount of computational resources which have been assigned to the computational processes other than the analysis of the photographed image 200 and the amount of computational resources which have been reserved to be assigned to the computational processes other than the analysis of the photographed image 200.

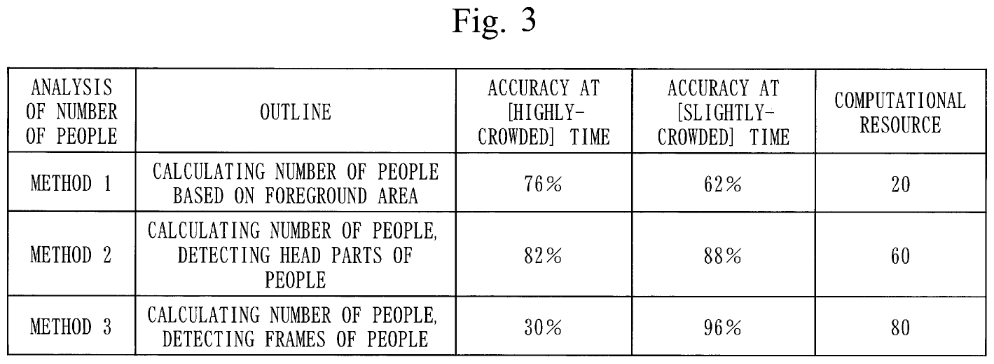

An analysis-method DB 109 stores an analysis-method table. In the analysis-method table, a plurality of methods are written, and realizable analysis accuracy and the required computational resource are written for each method. Details of the analysis-method table will be described later with reference to FIG. 3.

FIG. 2 illustrates a hardware configuration example of the information processing apparatus 100 according to the present embodiment.

The information processing apparatus 100 includes as pieces of hardware, a processor 901, a main storage device 902, an auxiliary storage device 903, and a communication device 904.

The auxiliary storage device 903 stores programs which realize functions of the image acquisition unit 101, the state deduction unit 102, the required-accuracy setting unit 103, the constraint-condition setting unit 104, the analysis-method selection unit 105, and the analysis processing unit 106.

These programs are loaded from the auxiliary storage device 903 into the main storage device 902. Then, the processor 901 executes these programs, and performs operation of the image acquisition unit 101, the state deduction unit 102, the required-accuracy setting unit 103, the constraint-condition setting unit 104, the analysis-method selection unit 105, and the analysis processing unit 106, which will be described later.

FIG. 2 schematically illustrates a situation where the processor 901 executes the programs which realize the functions of the image acquisition unit 101, the state deduction unit 102, the required-accuracy setting unit 103, the constraint-condition setting unit 104, the analysis-method selection unit 105, and the analysis processing unit 106.

The required-accuracy DB 107 and the analysis-method DB 109 are realized by the main storage device 902 or the auxiliary storage device 903.

FIG. 3 illustrates an example of the analysis-method table.

In the analysis-method table in FIG. 3, a method 1, a method 2, and a method 3 are written as the analysis methods executable by the analysis processing unit 106. In the present embodiment, an example will be described in which the analysis processing unit 106 analyzes the photographed image 200 showing people and calculates the number of people shown in the photographed image 200. Therefore, also, in the analysis-method table in FIG. 3, the method 1, the method 2, and the method 3 are written as methods of calculating the number of people shown in the photographed image 200. In the example of FIG. 3, the method 1 is a method of [calculating the number of people based on a foreground area] in the photographed image 200. The method 2 is a method of [calculating the number of people, detecting head parts of people] shown in the photographed image 200. The method 3 is a method of [calculating the number of people, detecting frames of people] shown in the photographed image 200.

Note that, [outline] indicated in FIG. 3 is an item provided for an explanation purpose, and in a practical use, the item of [outline] does not have to be included in the analysis-method table.

Further, in the analysis-method table in FIG. 3, the analysis accuracy in a case where the state presented in the photographed image 200 is a [highly-crowded] state and the analysis accuracy in a case where the state presented in the photographed image 200 is a [slightly-crowded] state are written for each method. Further, in the analysis-method table in FIG. 3, the computational resource required for the analysis is written for each method.

For example, when the method 1 is used, 76% analysis accuracy is obtained if the state presented in the photographed image 200 is the [highly-crowded] state. On the other hand, 62% analysis accuracy is obtained if the state presented in the photographed image 200 is the [slightly-crowded] state. Further, when the method 1 is used, [20] is required as the computational resource. Further, when the method 2 is used, [60] is required as the computational resource. Further, when the method 3 is used, [80] is required as the computational resource.

### Description of Operation

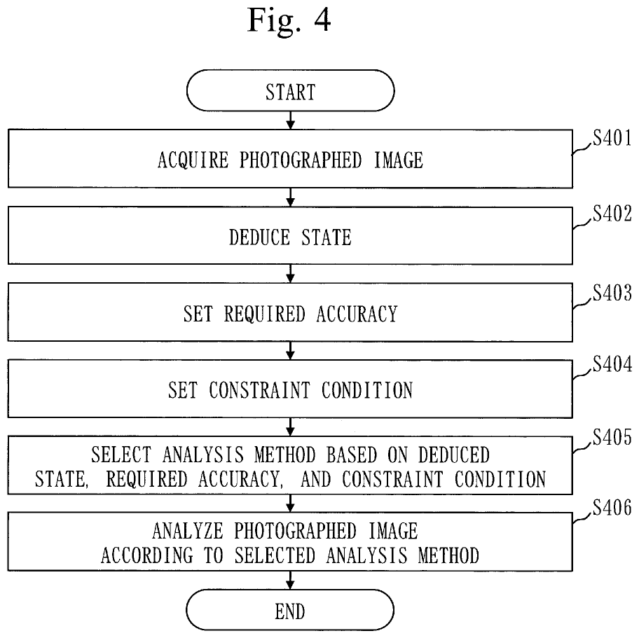

Next, with reference to FIG. 4, an operation example of the information processing apparatus 100 according to the present embodiment will be described.

First, in step S401, the image acquisition unit 101 acquires the photographed image 200. The photographed image 200 is presumed to show people.

Next, in step S402, the state deduction unit 102 analyzes the photographed image 200 uncomplicatedly and deduces the state presented in the photographed image 200. More specifically, the state deduction unit 102 deduces whether the state presented in the photographed image 200 is the [highly-crowded] state indicated in FIG. 3 or the [slightly-crowded] state indicated in FIG. 3. For example, the state deduction unit 102 deduces whether the state presented in the photographed image 200 is the [highly-crowded] state or the [slightly-crowded] state, based on a size of a foreground area shown in the photographed image 200.

Then, the state deduction unit 102 notifies the analysis-method selection unit 105 of the deduced state deduced.

Next, in step S403, the required-accuracy setting unit 103 sets the required accuracy.

The required-accuracy setting unit 103 notifies the analysis-method selection unit 105 of the required accuracy set.

Next, in step S404, the constraint-condition setting unit 104 sets the constraint condition.

The constraint-condition setting unit 104 specifies the amount of computational resources which are being used for the other computational processes in the information processing apparatus 100, referring to the constraint information 108, and sets as the constraint condition, the amount of computational resources which can be assigned to an analysis process of the analysis processing unit 106.

The constraint-condition setting unit 104 notifies the analysis-method selection unit 105 of the set constraint condition.

Next, in step S405, the analysis-method selection unit 105 selects the analysis method based on the deduced state, the required accuracy, and the constraint condition.

The analysis-method selection unit 105 notifies the analysis processing unit 106 of the selected analysis method.

Next, in step S406, the analysis processing unit 106 analyzes the photographed image 200 according to the analysis method selected by the analysis-method selection unit 105.

In FIG. 4, an example is indicated of performing the processes in order of step S402, step S403, step S404. However, step S402, step S403, and step S404 may be performed concurrently.

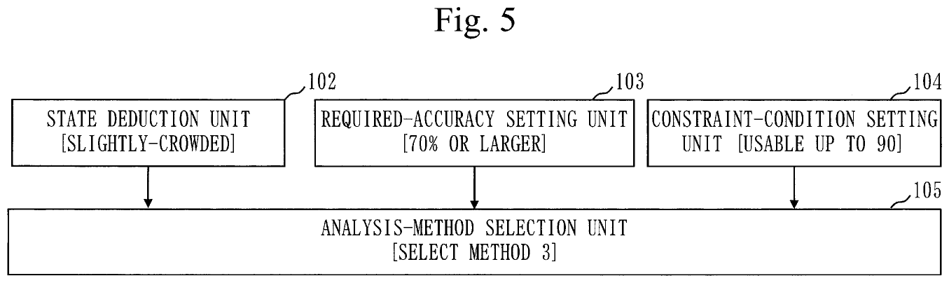

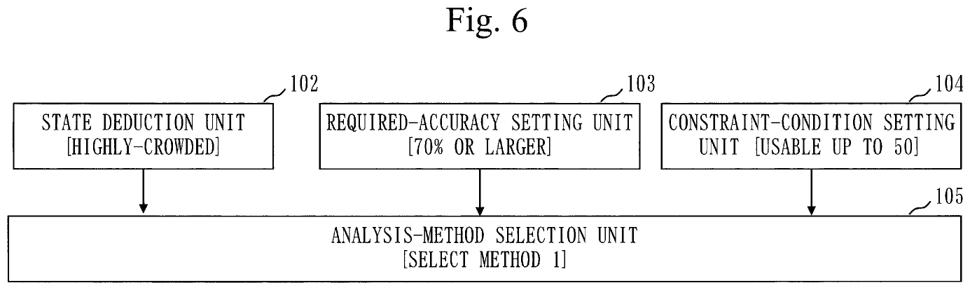

FIGS. 5 and 6 illustrate specific examples of operation of the information processing apparatus 100.

Below, with reference to FIGS. 5 and 6, the operation of the information processing apparatus 100 will be specifically described.

In FIG. 5, the state deduction unit 102 deduces the state presented in the photographed image 200 as the [slightly-crowded] state. Further, the required-accuracy setting unit 103 sets [70% or larger] as the required accuracy. Further, the constraint-condition setting unit 104 sets the computational resource to [usable up to 90] as the constraint condition.

The analysis-method selection unit 105 refers to the analysis-method table in FIG. 3. In the example of FIG. 5, the analysis-method selection unit 105 selects the method 3 according to which accuracy in a case of [slightly-crowded] is “96%” (which satisfies the required accuracy of [70% or larger]) and the computational resource is “80” (which satisfies the constraint condition of [usable up to 90]).

Note that, in the example of FIG. 5, the method 2 also satisfies the required accuracy and the constraint condition. In the present embodiment, if there exist a plurality of selectable methods, the analysis-method selection unit 105 selects a method with higher accuracy. Therefore, the analysis-method selection unit 105 selects the method 3. Alternatively, if there exist the plurality of selectable methods, the analysis-method selection unit 105 may select a method which requires less computational resources. In this case, the analysis-method selection unit 105 selects the method 2.

For a case where there exist the plurality of selectable methods, it is presumed that a selection criterion is defined in, for example, the analysis-method DB 109, as to which of the analysis accuracy and the computational resource is prioritized by the analysis-method selection unit 105. When there exist the plurality of selectable methods, the analysis-method selection unit 105 selects a method conforming to the selection criterion defined in the analysis-method DB 109.

In FIG. 6, the state deduction unit 102 deduces the state presented in the photographed image 200 as the [highly-crowded] state. Further, the required-accuracy setting unit 103 sets [70% or larger] as the required accuracy. Further, the constraint-condition setting unit 104 sets the computational resource to [usable up to 50] as the constraint condition.

The analysis-method selection unit 105 refers to the analysis-method table in FIG. 3. In an example of FIG. 6, the analysis-method selection unit 105 selects the method 1 according to which accuracy in a case of [highly-crowded] is “76%” (which satisfies the required accuracy of [70% or larger]) and the computational resource is “20” (which satisfies the constraint condition of [usable up to 50]).

### Description of Effect of Embodiment

As described above, according to the present embodiment, it is possible to realize proper analysis of the photographed image depending on the state, the required accuracy, and the constraint condition.

In the present embodiment, although the analysis of the number of people has been described as an example of the analysis of the photographed image 200, the analysis of the photographed image 200 is not limited to the analysis of the number of people.

Further, in the present embodiment, an example has been described in which the state deduction unit 102 classifies the state presented in the photographed image 200, as either the “highly-crowded” state or the “slightly-crowded” state. However, the state deduction unit 102 may classify the state presented in the photographed image 200, into more states. In this case, in the analysis-method table (FIG. 3), the analysis accuracy is specified in more detail according to the number of states into which the state deduction unit 102 makes the classification. Further, the analysis-method table may include more pieces of information than the pieces of information indicated in FIG. 3 regardless of the number of states into which the state deduction unit 102 makes the classification.

Further, in the present embodiment, the required-accuracy setting unit 103 sets the required accuracy, and the constraint-condition setting unit 104 sets the constraint condition. Instead of this, the information processing apparatus 100 may acquire the required accuracy and the constraint condition from the outside of the information processing apparatus 100. In this case, the required-accuracy setting unit 103 and the constraint-condition setting unit 104 are unnecessary.

### Second Embodiment

In the present embodiment, mainly matters different from the first embodiment will be described.

Note that, matters not described below are the same as those in the first embodiment.

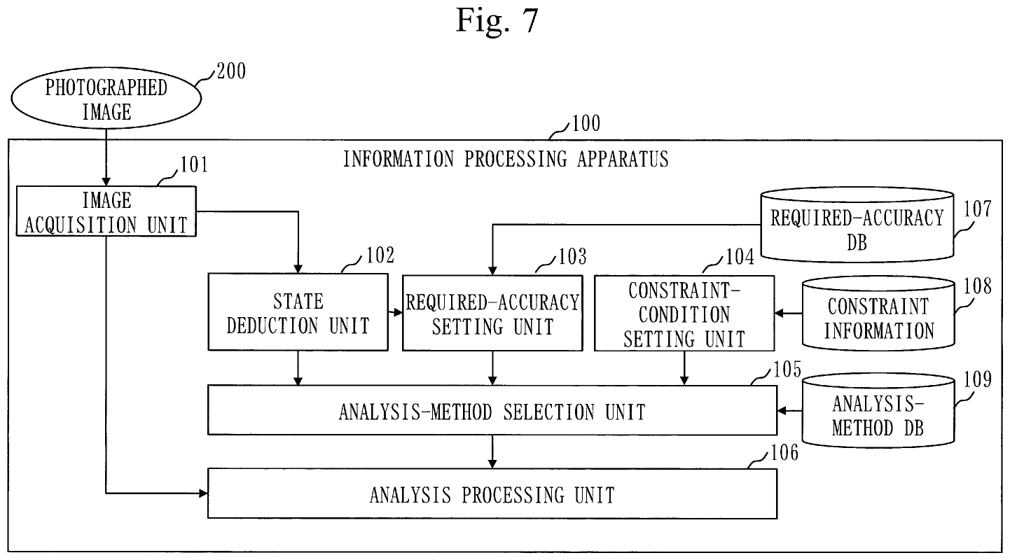

FIG. 7 illustrates a functional configuration example of the information processing apparatus 100 according to the present embodiment.

In FIG. 7, the state deduction unit 102 notifies the required-accuracy setting unit 103 of the deduced state. Then, the required-accuracy setting unit 103 sets the required accuracy based on the deduced state.

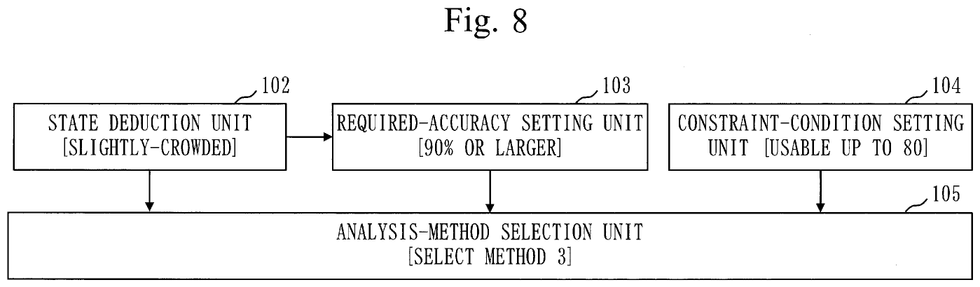

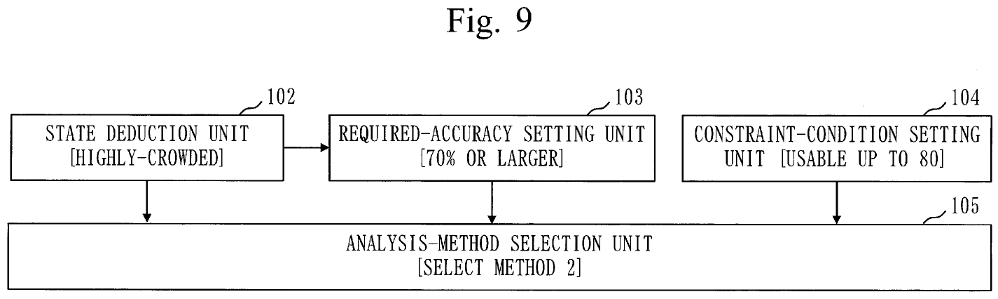

FIGS. 8 and 9 illustrate specific examples of operation of the information processing apparatus 100 according to the present embodiment.

In FIG. 8, the state deduction unit 102 deduces the state presented in the photographed image 200 as the [slightly-crowded] state. The state deduction unit 102 notifies the required-accuracy setting unit 103 that the state presented in the photographed image 200 is the [slightly-crowded] state. The required-accuracy setting unit 103 sets [90% or larger] as the required accuracy in response to a deduction that the state presented in the photographed image 200 is the [slightly-crowded] state. Further, the constraint-condition setting unit 104 sets the computational resource to [usable up to 80] as the constraint condition.

The analysis-method selection unit 105 refers to the analysis-method table in FIG. 3. In the example of FIG. 8, the analysis-method selection unit 105 selects the method 3 according to which the accuracy in the case of [slightly-crowded] is “96%” (which satisfies the required accuracy of [90% or larger]) and the computational resource is “80” (which satisfies the constraint condition of [usable up to 80]).

In FIG. 9, the state deduction unit 102 deduces the state presented in the photographed image 200 as the [highly-crowded] state. The state deduction unit 102 notifies the required-accuracy setting unit 103 that the state presented in the photographed image 200 is the [highly-crowded] state. The required-accuracy setting unit 103 sets [70% or larger] as the required accuracy in response to a deduction that the state presented in the photographed image 200 is the [highly-crowded] state. Further, the constraint-condition setting unit 104 sets the computational resource to [usable up to 80] as the constraint condition.

The analysis-method selection unit 105 refers to the analysis-method table in FIG. 3. In the example of FIG. 9, the analysis-method selection unit 105 selects the method 2 according to which the accuracy in the case of [highly-crowded] is “82%” (which satisfies the required accuracy of [70% or larger]) and the computational resource is “60” (which satisfies the constraint condition of [usable up to 80]).

Note that, in the example of FIG. 9, the method 1 also satisfies the required accuracy and the constraint condition. In the present embodiment, if there exist a plurality of selectable methods, the analysis-method selection unit 105 selects a method with higher accuracy. Therefore, the analysis-method selection unit 105 selects the method 2. Alternatively, if there exist the plurality of selectable methods, the analysis-method selection unit 105 may select a method which requires less computational resources. In this case, the analysis-method selection unit 105 selects the method 1.

If there exists no method which satisfies both of the required accuracy and the constraint condition, the analysis-method selection unit 105 performs a predetermined error process.

For example, if there is a method (hereinafter, referred to as a “method X”) which does not satisfy the required accuracy but satisfies the constraint condition, the analysis-method selection unit 105 notifies a user of the information processing apparatus 100 that the method X does not satisfy the required accuracy but satisfies the constraint condition, as the error process. If the user of the information processing apparatus 100 accepts the method X, the analysis-method selection unit 105 selects the method X.

The analysis-method DB 109 is presumed to define details of the error processes for each of a case where only the required accuracy is not satisfied, a case where only the constraint condition is not satisfied, and a case where both the required accuracy and the constraint condition are not satisfied. The analysis-method selection unit 105 performs the error process corresponding to each case according to the definition in the analysis-method DB 109.

According to the present embodiment, it is possible to select the analysis method which can realize the accuracy corresponding to the state presented in the photographed image.

### Third Embodiment

In the present embodiment, mainly matters different from the first embodiment will be described.

Note that, matters not described below are the same as those in the first embodiment.

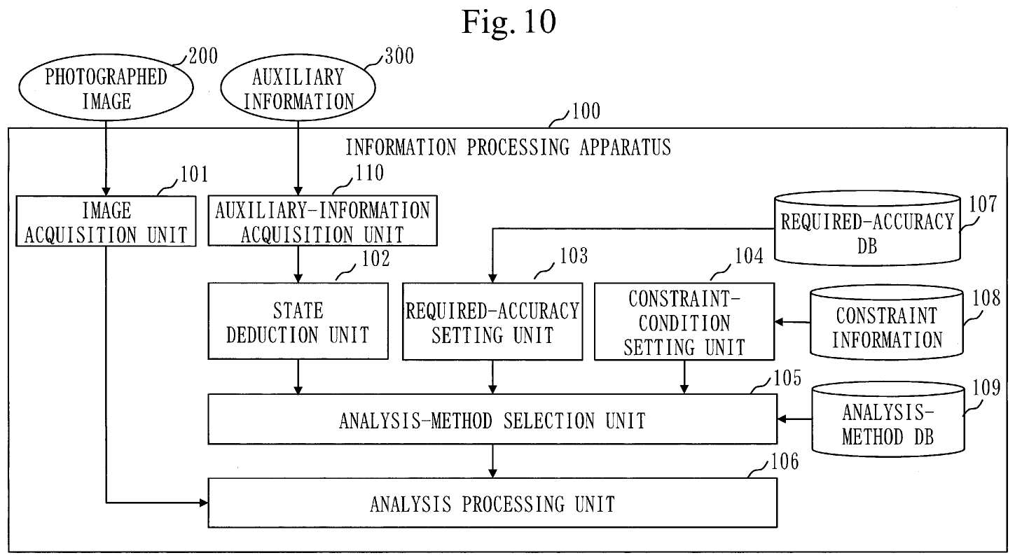

FIG. 10 illustrates a functional configuration example of the information processing apparatus 100 according to the present embodiment.

In FIG. 10, an auxiliary-information acquisition unit 110 is added compared with FIG. 1. Further, the auxiliary-information acquisition unit 110 acquires auxiliary information 300. The auxiliary-information acquisition unit 110 outputs the acquired auxiliary information 300 to the state deduction unit 102. A function of the auxiliary-information acquisition unit 110 is realized by, for example, a program as with the image acquisition unit 101 and the like. The program which realizes the function of the auxiliary-information acquisition unit 110 is executed by the processor 901.

The auxiliary information 300 is information other than the photographed image 200. The auxiliary information 300 is, for example, information indicating a measurement result of an infrared sensor, information indicating a measurement result of a gravity sensor, or information indicating a measurement result of a temperature sensor. Further, the auxiliary information 300 may be an image photographed by a different camera from a camera used for the photographed image 200. For example, if the auxiliary-information acquisition unit 110 acquires as the auxiliary information 300, the information indicating the measurement result of the infrared sensor, the state deduction unit 102 can analyze the measurement result of the infrared sensor and deduce the state (the highly-crowded state or the slightly-crowded state) presented in the photographed image 200.

Further, the auxiliary-information acquisition unit 110 can acquire, for example, precipitation information as the auxiliary information 300. In this case, the state deduction unit 102 can deduce that people open umbrellas, and deduce the state presented in the photographed image 200.

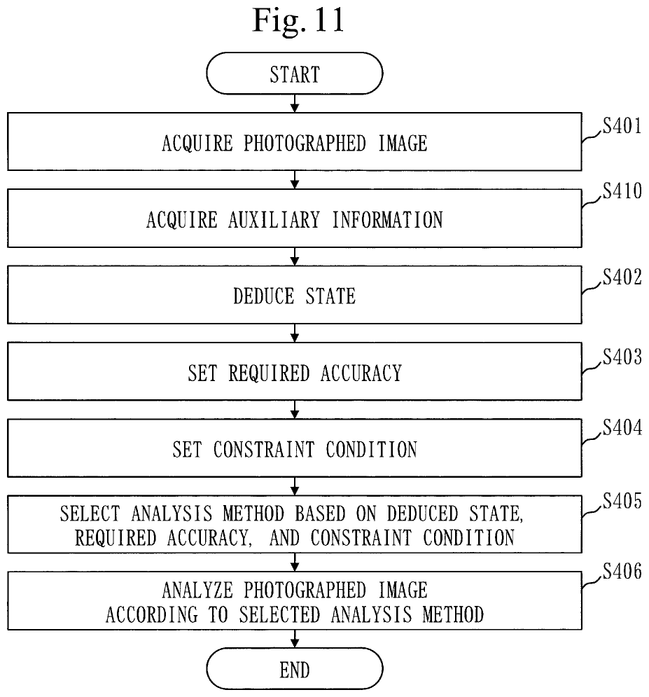

FIG. 11 illustrates an operation example of the information processing apparatus 100 according to the present embodiment.

In a flowchart of FIG. 11, step S410 is added.

In step S410, the auxiliary-information acquisition unit 110 acquires the auxiliary information 300. The auxiliary-information acquisition unit 110 outputs the acquired auxiliary information 300 to the state deduction unit 102.

In step S402, the state deduction unit 102 deduces the state presented in the photographed image 200, using the auxiliary information 300.

Since step S401, step S403, and steps after step S403 are the same as those indicated in FIG. 4, descriptions thereof will be omitted.

Note that, in FIG. 11, although an example has been indicated of performing the processes in order from step S401 to step S410, step S401 and step S410 may be performed concurrently.

Consequently, according to the present embodiment, it is possible to more correctly deduce the state presented in the photographed image, by using the auxiliary information.

### Fourth Embodiment

In the present embodiment, mainly matters different from the third embodiment will be described.

Note that, matters not described below are the same as those in the third embodiment.

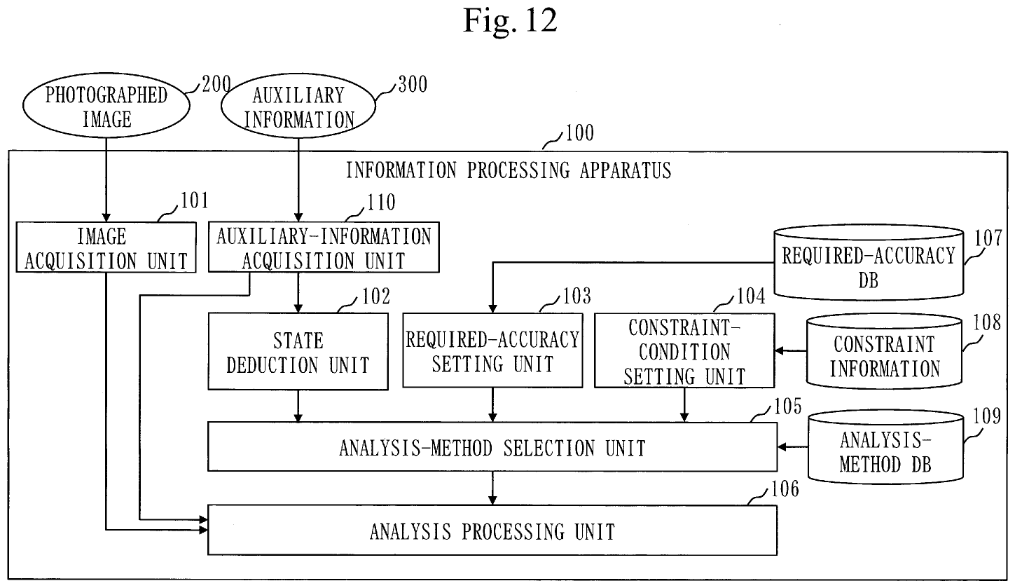

In the third embodiment, an example has been described in which the auxiliary information 300 is used only for the deduction of the state by the state deduction unit 102. In the present embodiment, the auxiliary information 300 is used also for the analysis by the analysis processing unit 106. For example, as illustrated in FIG. 12, the auxiliary-information acquisition unit 110 outputs the auxiliary information 300 to the analysis processing unit 106. Then, the analysis processing unit 106 analyzes the photographed image 200, using the auxiliary information 300 together with the photographed image 200.

For example, if the auxiliary-information acquisition unit 110 acquires as the auxiliary information 300, the information indicating the measurement result of the infrared sensor, the analysis processing unit 106 can analyze the measurement result of the infrared sensor and more correctly calculate the number of people presented in the photographed image 200. Further, if the auxiliary-information acquisition unit 110 acquires the precipitation information as the auxiliary information 300, the analysis processing unit 106 can deduce that the people open the umbrellas, and calculate the number of people.

Further, the auxiliary-information acquisition unit 110 may output the auxiliary information 300 to the analysis-method selection unit 105. In this case, the analysis-method selection unit 105 selects the analysis method, referring to the auxiliary information 300. For example, if the auxiliary-information acquisition unit 110 acquires the precipitation information as the auxiliary information 300, the analysis-method selection unit 105 selects an analysis method which can calculate the number of people even in the state where the people open the umbrellas.

Consequently, according to the present embodiment, the analysis processing unit can more correctly analyze the photographed image, by using the auxiliary information.

### Fifth Embodiment

In the present embodiment, mainly matters different from the first embodiment will be described.

Note that, matters not described below are the same as those in the first embodiment.

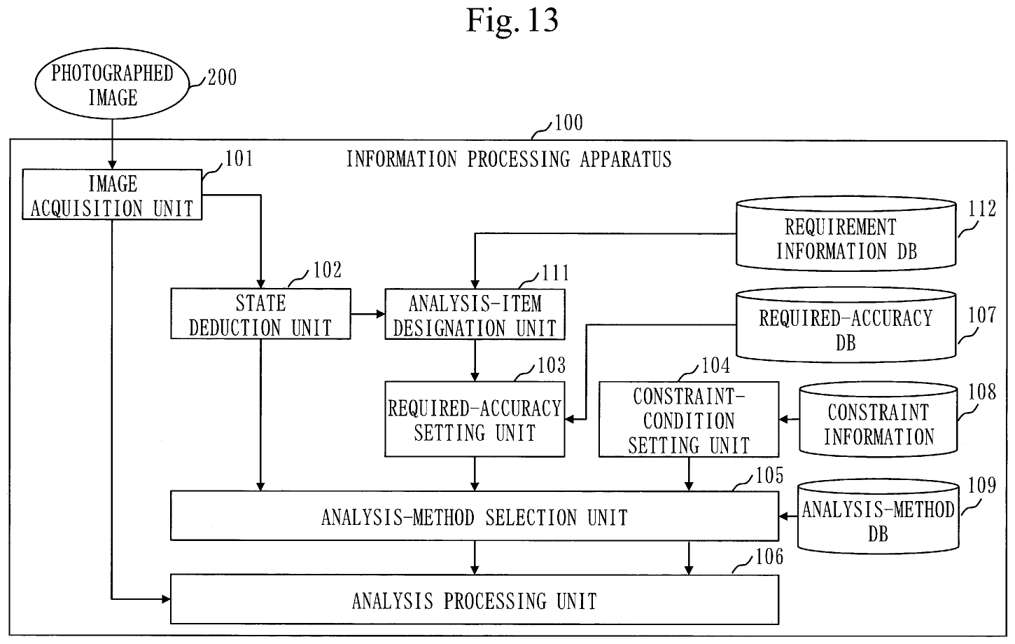

FIG. 13 illustrates a functional configuration example of the information processing apparatus 100 according to the present embodiment.

In FIG. 13, an analysis-item designation unit 111 and a requirement information DB 112 are added compared with FIG. 1.

The analysis-item designation unit 111 is notified of the deduced state by the state deduction unit 102. Then, the analysis-item designation unit 111 designates two or more analysis items (for example, [analysis of the number of people] and [detection of an intoxicated person]), based on the deduced state notified of. The analysis item is a category of the analysis performed by the analysis processing unit 106. A function of the analysis-item designation unit 111 is realized by, for example, a program as with the image acquisition unit 101 and the like. The program which realizes the function of the analysis-item designation unit 111 is executed by the processor 901.

The requirement information DB 112 stores a requirement information table. In the requirement information table, a plurality of states are written, and the analysis item is written for each of the plurality of states. The analysis-item designation unit 111 designates the two or more analysis items according to writing in the requirement information table.

In the present embodiment, the required-accuracy setting unit 103 sets the required accuracy for each analysis item. Further, the analysis-method selection unit 105 selects the analysis method for each analysis item.

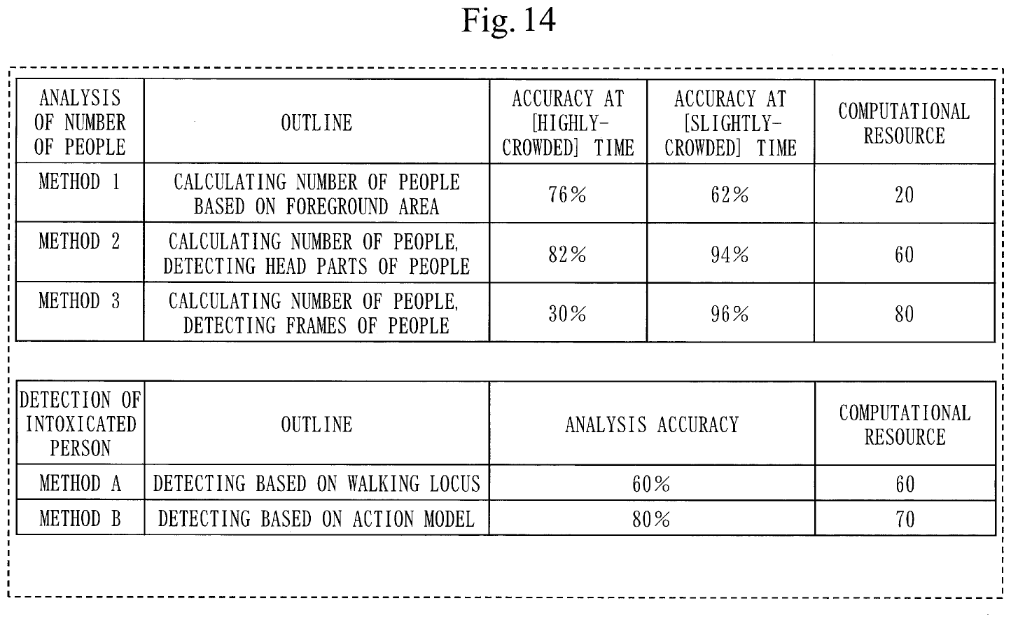

FIG. 14 illustrates examples of the analysis-method tables according to the present embodiment.

The analysis-method tables in FIG. 14 correspond to two analysis items. That is, the analysis-method tables in FIG. 14 correspond to respective two analysis items which are “analysis of the number of people” and “detection of an intoxicated person”.

The analysis-method table regarding “analysis of the number of people” is the same as that illustrated in FIG. 3.

In the analysis-method table regarding “detection of an intoxicated person”, a method A and a method B are written as the analysis methods executable for the analysis processing unit 106. In the present embodiment, an example of “detection of an intoxicated person” will be described in which the analysis processing unit 106 analyzes the photographed image 200 and determines whether or not there exists a person in an intoxication state in the photographed image 200. In the example of FIG. 14, the method A is a method of [detecting based on a walking locus]. The method B is a method of [detecting based on an action model].

Also in FIG. 14, [outline] is an item provided for an explanation purpose, and in a practical use, the item of [outline] does not have to be included in the analysis-method table.

Further, also in the analysis-method table regarding [detection of an intoxicated person] in FIG. 14, the analysis accuracy is written for each method. Further, also in the analysis-method table regarding [detection of an intoxicated person] in FIG. 14, the required computational resource is written for each method.

For example, when the method A is used, 60% analysis accuracy is obtained. On the other hand, when the method B is used, 800% analysis accuracy is obtained. Further, when the method A is used, [60] is required as the computational resource. Further, when the method B is used, [70] is required as the computational resource.

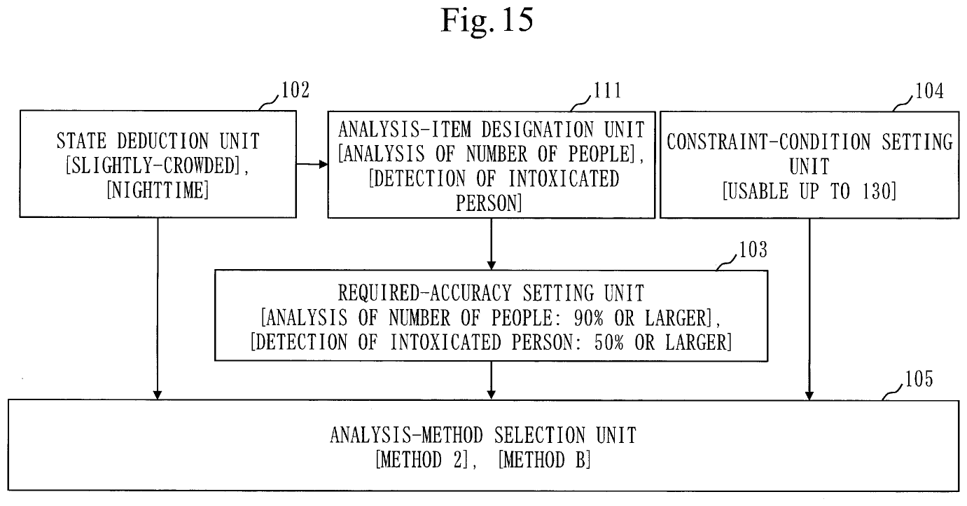

FIG. 15 illustrates a specific example of operation of the information processing apparatus 100 according to the present embodiment.

In FIG. 15, the state deduction unit 102 deduces the state presented in the photographed image 200 as [slightly-crowded] and [nighttime]. The state deduction unit 102 notifies the analysis-item designation unit 111 of the deduced states.

The analysis-item designation unit 111 refers to the requirement information table. In the present embodiment, in the requirement information table, [analysis of the number of people] is presumed to be written for [slightly-crowded] and [highly-crowded], and [detection of an intoxicated person] is presumed to be written for [nighttime]. The analysis-item designation unit 111 designates [analysis of the number of people] and [detection of an intoxicated person] as the analysis items based on the deduced states notified of by the state deduction unit 102 and the writing in the requirement information table. Further, the analysis-item designation unit 111 notifies the required-accuracy setting unit 103 of [analysis of the number of people] and [detection of an intoxicated person] as the analysis items.

In FIG. 15, the required-accuracy setting unit 103 sets [90% or larger] as the required accuracy for [analysis of the number of people]. Further, the required-accuracy setting unit 103 sets [50% or larger] as the required accuracy for [detection of an intoxicated person].

Further, the constraint-condition setting unit 104 sets the computational resource to [usable up to 130] as the constraint condition.

The analysis-method selection unit 105 refers to the analysis-method tables in FIG. 14. In the example of FIG. 15, the analysis-method selection unit 105 selects as the method of [analysis of the number of people], the method 2 according to which the accuracy in the case of [slightly-crowded] is “94%” (which satisfies the required accuracy of [90% or larger]). Further, the analysis-method selection unit 105 selects as the method of [detection of an intoxicated person], the method B according to which the accuracy is “80%” (which satisfies the required accuracy of [50% or larger]). Since a sum of the computational resources of the method 2 and the method B is “130” (which satisfies the constraint condition of [usable up to 130]), the analysis-method selection unit 105 is able to select the method 2 and the method B.

The analysis-method selection unit 105 is able to select the method A as the method of [detection of an intoxicated person]. However, the analysis-method selection unit 105 selects the method B here, since the method B satisfies the constraint condition and has higher analysis accuracy.

Consequently, according to the present embodiment, it is possible to perform an analysis for each of a plurality of analysis items at the accuracy proper for each of the plurality of analysis items.

### Sixth Embodiment

In the present embodiment, mainly matters different from the first embodiment will be described.

Note that, matters not described below are the same as those in the first embodiment.

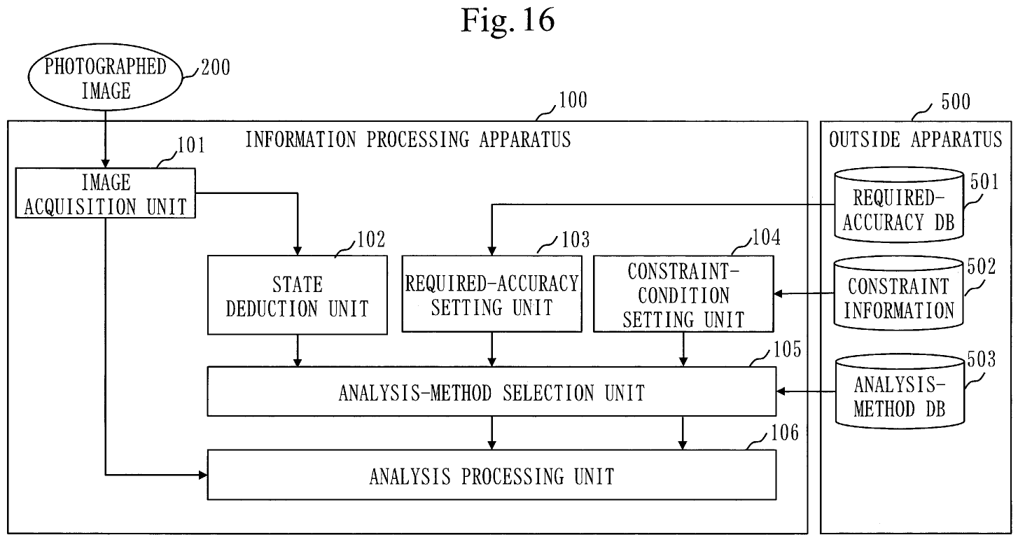

FIG. 16 illustrates a functional configuration example of the information processing apparatus 100 according to the present embodiment.

In FIG. 16, the required-accuracy DB 107, the constraint information 108, and the analysis-method DB 109 placed in the information processing apparatus 100 in FIG. 1 are placed in an outside apparatus 500, as a required-accuracy DB 501, constraint information 502, and an analysis-method DB 503, as respectively.

That is, in the present embodiment, the required-accuracy setting unit 103 acquires the required-accuracy table from the required-accuracy DB 501 instead of the required-accuracy DB 107.

Further, the constraint-condition setting unit 104 refers to the constraint information 502 instead of the constraint information 108.

Further, the analysis-method selection unit 105 acquires the analysis-method table from the analysis-method DB 503 instead of the analysis-method DB 109.

According to the present embodiment, it is possible to simplify the configuration of the information processing apparatus 100.

### Seventh Embodiment

In the present embodiment, mainly matters different from the first embodiment will be described.

Note that, matters not described below are the same as those in the first embodiment.

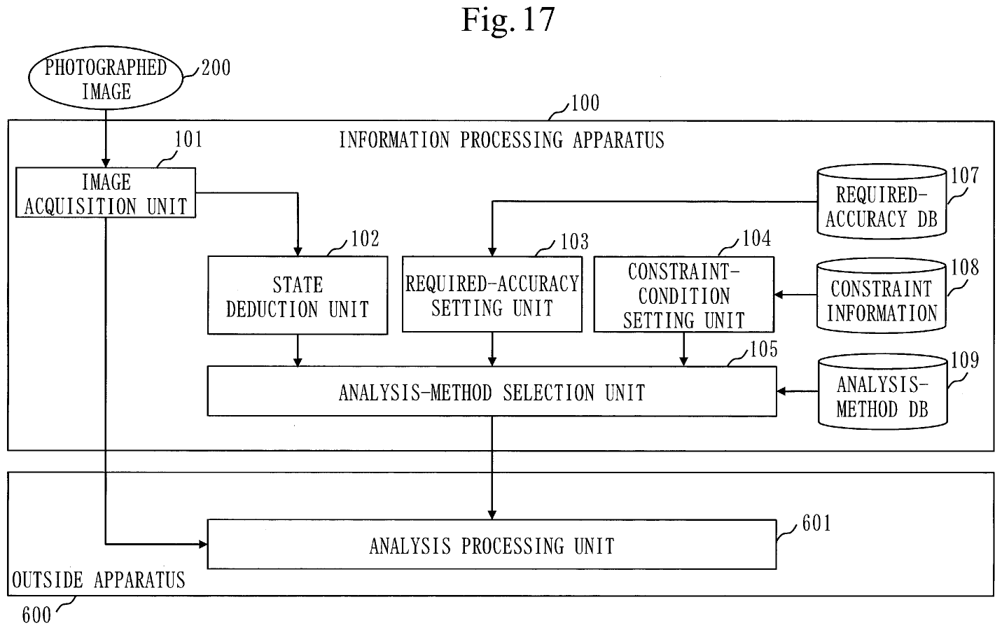

FIG. 17 illustrates a functional configuration example of the information processing apparatus 100 according to the present embodiment.

In FIG. 17, the analysis processing unit 106 placed in the information processing apparatus 100 in FIG. 1 is placed in an outside apparatus 600, as an analysis processing unit 601.

Operation of the analysis processing unit 601 is the same as that of the analysis processing unit 106.

In the present embodiment, the image acquisition unit 101 outputs the photographed image 200 to the analysis processing unit 601. Further, the analysis-method selection unit 105 notifies the analysis processing unit 601 of the selected analysis method. Then, the analysis-method selection unit 105 causes the analysis processing unit 601 to execute the analysis process according to the selected analysis method.

In the present embodiment, the constraint-condition setting unit 104 sets as the constraint condition, a constraint condition as to a cost required for the analysis of the photographed image 200 by the analysis processing unit 601. That is, in the first embodiment, since the analysis processing unit 106 performs the analysis process, using the computational resources in the information processing apparatus 100, the constraint-condition setting unit 104 sets the constraint condition as to the computational resource. In the present embodiment, no constraint as to the computational resource in the information processing apparatus 100 is involved in the analysis process by the analysis processing unit 601. However, when the analysis process is executed by the outside apparatus 600, the cost (expense) required for the analysis process is incurred. Therefore, in the present embodiment, the constraint-condition setting unit 104 sets as the constraint condition, the constraint condition as to the cost required for the analysis of the photographed image 200 by the outside apparatus 600.

According to the present embodiment as well, it is possible to simplify the configuration of the information processing apparatus 100.

Although the first to seventh embodiments have been described above, two or more of these embodiments may be combined and implemented.

Alternatively, one of these embodiments may be partially implemented.

Alternatively, two or more of these embodiments may be partially combined and implemented.

Further, the configurations and the procedures described in these embodiments may be modified as necessary.

***Supplementary Description of Hardware Configuration***

Finally, supplementary descriptions of the hardware configuration of the information processing apparatus 100 will be given.

The processor 901 illustrated in FIG. 2 is an IC (Integrated Circuit) that performs processing.

The processor 901 is a CPU (Central Processing Unit), a DSP (Digital Signal Processor), or the like.

The main storage device 902 illustrated in FIG. 2 is a RAM (Random Access Memory).

The auxiliary storage device 903 illustrated in FIG. 2 is a ROM (Read Only Memory), a flash memory, an HDD (Hard Disk Drive), or the like.

The communication device 904 illustrated in FIG. 2 is an electronic circuit that executes a communication process of data.

The communication device 904 is, for example, a communication chip or an NIC (Network Interface Card).

Further, the auxiliary storage device 903 also stores an OS (Operating System).

Then, at least a part of the OS is executed by the processor 901.

While executing at least the part of the OS, the processor 101 executes the programs which realize the functions of the image acquisition unit 101, the state deduction unit 102, the required-accuracy setting unit 103, the constraint-condition setting unit 104, the analysis-method selection unit 105, the analysis processing unit 106, the auxiliary-information acquisition unit 110, and the analysis-item designation unit 111.

By the processor 901 executing the OS, task management, memory management, file management, communication control, and the like are performed.

Further, at least one of information, data, a signal value, and a variable value that indicate results of processes of the image acquisition unit 101, the state deduction unit 102, the required-accuracy setting unit 103, the constraint-condition setting unit 104, the analysis-method selection unit 105, the analysis processing unit 106, the auxiliary-information acquisition unit 110, and the analysis-item designation unit 111 is stored in at least one of the main storage device 902, the auxiliary storage device 903, and a register and a cash memory in the processor 901.

Further, the programs which realize the functions of the image acquisition unit 101, the state deduction unit 102, the required-accuracy setting unit 103, the constraint-condition setting unit 104, the analysis-method selection unit 105, the analysis processing unit 106, the auxiliary-information acquisition unit 110, and the analysis-item designation unit 111 may be stored in a portable recording medium such as a magnetic disk, a flexible disk, an optical disc, a compact disc, a Blu-ray (registered trademark) disc, or a DVD. Then, the portable recording medium storing the programs which realize the functions of the image acquisition unit 101, the state deduction unit 102, the required-accuracy setting unit 103, the constraint-condition setting unit 104, the analysis-method selection unit 105, the analysis processing unit 106, the auxiliary-information acquisition unit 110, and the analysis-item designation unit 11I may be distributed.

Further, “unit” of the image acquisition unit 101, the state deduction unit 102, the required-accuracy setting unit 103, the constraint-condition setting unit 104, the analysis-method selection unit 105, the analysis processing unit 106, the auxiliary-information acquisition unit 110, and the analysis-item designation unit IIl may be replaced by “circuit”, “step”. “procedure”, or “process”.

Further, the information processing apparatus 100 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

Note that, in the present specification, a superordinate concept of the processor and the processing circuit is referred to as “processing circuitry”.

That is, each of the processor and the processing circuit is a specific example of the “processing circuitry”.

### REFERENCE SIGNS LIST

100: information processing apparatus, 101: image acquisition unit, 102: state deduction unit, 103: required-accuracy setting unit, 104: constraint-condition setting unit, 105: analysis-method selection unit, 106: analysis processing unit, 107: required-accuracy DB, 108: constraint information, 109: analysis-method DB, 110: auxiliary-information acquisition unit, 111: analysis-item designation unit, 112: requirement information DB, 200: photographed image, 300: auxiliary information, 500: outside apparatus, 501: required-accuracy DB, 502: constraint information, 503: analysis-method DB, 600: outside apparatus, 601: analysis processing unit, 901: processor, 902: main storage device, 903: auxiliary storage device, 904: communication device.

1. An information processing apparatus comprising:
processing circuitry
to deduce a state presented in a photographed image; and
to select as an analysis method for analyzing the photographed image, an analysis method from among a plurality of analysis methods, based on a deduced state which is the state deduced, required accuracy which is analysis accuracy required for analysis of the photographed image, and a constraint condition for analyzing the photographed image.

2. The information processing apparatus according to claim 1, wherein
analysis accuracy of each of the plurality of analysis methods differs depending on each of a plurality of states, and
the processing circuitry
deduces a state out of the plurality of states, as the state presented in the photographed image, and
selects an analysis method according to which the analysis accuracy of the deduced state satisfies the required accuracy and which further satisfies the constraint condition.

3. The information processing apparatus according to claim 1, wherein
the processing circuitry selects an analysis method from among the plurality of analysis methods, based on the required accuracy which has been set based on the deduced state.

4. The information processing apparatus according to claim 1, wherein
the processing circuitry deduces the state presented in the photographed image, using the photographed image.

5. The information processing apparatus according to claim 1, wherein
the processing circuitry
acquires as auxiliary information, information other than the photographed image, and
deduces the state presented in the photographed image, using the auxiliary information.

6. The information processing apparatus according to claim 1, wherein
the processing circuitry
designates two or more analysis items regarding the photographed image,
acquires the required accuracy for each of the two or more analysis items, and
selects the analysis method for each of the two or more analysis items.

7. The information processing apparatus according to claim 6, wherein
the processing circuitry designates the two or more analysis items based on the deduced state.

8. The information processing apparatus according to claim 1, wherein
the processing circuitry analyzes the photographed image according to the analysis method selected.

9. The information processing apparatus according to claim 8, wherein
the processing circuitry
acquires as auxiliary information, information other than the photographed image, and
analyzes the photographed image, using the auxiliary information.

10. The information processing apparatus according to claim 1, wherein
the processing circuitry selects an analysis method from among the plurality of analysis methods, based on a constraint condition of computational resources.

11. The information processing apparatus according to claim 1, wherein
the processing circuitry notifies an outside apparatus of the selected analysis method and causes the outside apparatus to execute the analysis of the photographed image according to the selected analysis method.

12. The information processing apparatus according to claim 11, wherein
the processing circuitry selects an analysis method from among the plurality of analysis methods, based on a constraint condition of a cost required for the analysis of the photographed image by the outside apparatus.

13. An information processing method comprising:
deducing a state presented in a photographed image; and
selecting as an analysis method for analyzing the photographed image, an analysis method from among a plurality of analysis methods, based on a deduced state which is the state deduced, required accuracy which is analysis accuracy required for analysis of the photographed image, and a constraint condition for analyzing the photographed image.

14. A non-transitory computer readable medium storing an information processing program which causes a computer to execute:
a state deduction process of deducing a state presented in a photographed image; and
an analysis-method selection process of selecting as an analysis method for analyzing the photographed image, an analysis method from among a plurality of analysis methods, based on a deduced state which is the state deduced by the state deduction process, required accuracy which is analysis accuracy required for analysis of the photographed image, and a constraint condition for analyzing the photographed image.
